(19) United States
(12) Patent Application Publication
(10) Pub. No.: US 2008/0136614 A1
(43) Pub. Date: Jun. 12, 2008

(54) Method and Apparatus For Detecting an Automobile's Window Regulating Status

(76) Inventor: Ping Ran, Shanghai (CN)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/908,386

(22) PCT Filed: Mar. 15, 2006
(86) PCT No.: PCT/EP06/60723

§ 371 Date: Oct. 23, 2007

(30) Foreign Application Priority Data
Mar. 16, 2005 (CN) 2005 10 055 511.4

(51) Int. Cl. G08B 21/00

(52) U.S. Cl. 340/438

(57) ABSTRACT

A method and apparatus for detecting an automobile's window regulating status uses a window control switch and a central controller, which receives window regulating requests from the window control switch, sends instructions to windows concerned and makes queries to window motors concerned regarding each window's regulating status. If a concerned window fails to execute a relevant instruction correctly, the central controller actuates an alarm to send out an alarming signal.

### CROSS-REFERENCE TO RELATED APPLICATIONS

This application is a U.S. national stage application of International Application No. PCT/EP2006/060723 filed Mar. 15, 2006, which designates the United States of America, and claims priority to Chinese application number 2005 10 055 511.4 filed Mar. 16, 2005, the contents of which are hereby incorporated by reference in their entirety.

### TECHNICAL FIELD

The present invention relates to an automobile passive safety system, and more particularly, to an automobile's window regulating control apparatus.

### BACKGROUND

Conventional medium and top grade automobiles are all fitted with door and window global shutting function (global closing). Usually it is actuated by remote locking or central locking, and under the prerequisite of ensuring safety, windows' and sunroof's automatic shutting need to have automatic clamp-prevention function. If during a global shutting process an accident (including human element) occurs, which leads to a door or window shutting failure, it would created a hidden risk to the safety of the whole vehicle. This kind of cases can be, for example, when a driver leaves his vehicle, somebody with ill intention may deliberately block a window from shutting by using an obstruction object. Since there is no means to sense the abnormal shutting of the window, the automobile owner may not realize at this moment the abnormal interference to the door shutting by the other person. As a direct consequence, this kind of situation can lead to the theft of the automobile and even to human injury.

### SUMMARY

A method and apparatus can sense abnormalities occurred during an automobile's window shutting process and warn the automobile owner to take measures to deal with such abnormalities. According to an embodiment, a method for detecting an automobile's window regulating status by using at least one automobile window regulating controller for issuing regulating instructions directly to window equipment, a window central controller, and by using a bus as the protocol for communication between automobile window regulating motors and the central window controller, may comprise the steps:

### S1) issuing a window regulating request by said at least one window regulating controller to said central controller via said bus;

### S2) receiving by said central controller the window regulating request issued by said at least one automobile window regulating controller, and issuing a regulating instruction to a window regulating motor of a respective window;

### S3) executing said window regulating instruction by said window regulating motor;

S4) making a query by said central controller to said window regulating motor regarding the execution status of the window's regulation, and reporting accordingly by said window regulating motor to said central controller the execution status of said instruction and
S4.1) examining by said central controller whether every window has completed its window regulating process: if “Yes”, stopping the window's regulating operation in a Step S6; if “No”, moving to a step S5;

### S5) judging whether the time for said window regulating motor to execute said window regulating instruction has gone beyond a limit, if “No”, moving to the step S4; if “Yes”, moving to a step S7 and

### S7) actuating by said central controller at least one alarm-unit to send out an alarming signal.

According to an enhancement, the step S4 may further comprise: S4.0, making a query by said central controller to at least one automobile door status sensor regarding an automobile door's shutting status, if “Yes”, moving to the step S4.1; if “No”, moving to the step S7. According to an enhancement, the communication bus between the central controller and window regulating motor can be a LIN bus, and said central controller can make queries periodically to said window regulating motor regarding the execution status of a window regulating instruction.

According to another embodiment, an apparatus for detecting an automobile's window regulating status, may comprise at least one automobile window regulating control switch, connected to a central controller, for issuing regulating requests to said central controller, wherein the central controller comprises communication connection with the at least one window regulating control switch and having connection with all window controllers by a bus protocol, for receiving from said at least one window regulating control switch the window regulating requests and issuing relevant instructions to a respective window motor controller; and for issuing query instructions to the respective window motor controller regarding the window's regulating status, and deciding whether the respective window should carry on the regulating operation or an alarm should be actuated according to the reply from the respective window motor controller; at least one window motor controller, for responding to the window regulating instruction from said central controller and actuating a window motor for a corresponding operation; and for responding to the query instruction regarding window regulating status from said central controller and sending a reply to said central controller and at least one alarm-unit for responding to an alarm instruction from said central controller to send out an alarming signal.

According to an enhancement, an automobile window regulating control switch can be selected form the group consisting of an automobile key, a central control lock and a manual window regulator usually attached to the inner side of an automobile door. According to an enhancement, the alarming signal can be selected from the group consisting of a sound alarm, a light alarm and a sound-light alarm. According to an enhancement, the alarm-unit may comprise a wireless communication device for sending a communication request/alarm signal to at least one fixed/mobile communication equipment; after said communication request has been received by a receiving party, it can follow a predetermined procedure to report to the receiving party by way of sound or digital signal which window is or which windows are abnormal and what types of abnormality have occurred. According to an enhancement, the apparatus may further comprise at least one automobile door status sensor for sensing whether an automobile door has shut and sending said signal to said central controller, and said central controller processes said signal to decide whether to give an alarming signal.

### BRIEF DESCRIPTION OF THE DRAWINGS

FIG. 1 shows a flow-chart of the method according to an embodiment and in parallel functional units to perform the single process steps.

### DETAILED DESCRIPTION

Generally speaking, the present invention provides a method and apparatus for detecting an automobile's window shutting status by using a window control switch, a central controller, which receives window regulating requests from the window control switch, sends instructions to windows concerned and makes queries to window motors concerned regarding each window's regulating status; if a concerned window fails to execute a relevant instruction correctly, the central controller actuates an alarm to send out an alarm signal.

According to one aspect, one embodiment provides a method, which uses a bus (such as a LIN bus) as a protocol for equipment communication, so a door controller can make queries via the LIN bus about the status of a clamp-prevention motor during the global shutting process, and once an abnormality is found (such as a window fails to shut) it will issue an alarming signal to attract the automobile owner's attention.

According to another aspect, another embodiment provides an apparatus, which comprises at least one type of automobile window control switch and a central controller, which can sense the windows' status during a shutting process, and to warn the automobile owner to take measures to eliminate any obstruction.

Specifically, according to one aspect, a method is disclosed for detecting whether an automobile's window is shut normally by using at least one automobile window regulating controller for issuing regulating instructions directly to window equipment, a window central controller, and by using a bus as the protocol for communication between automobile window motors and the window central controller, comprising:

### Step 1: issuing a window regulating request by said at least one window regulating controller to said central controller via said bus;

### Step 2: receiving by said central controller the window regulating request issued by said at least one automobile window regulating controller, and issuing a regulating instruction to a regulating motor of the window that said request concerns;

### Step 3: executing said window regulating instruction by said window regulating motor;

Step 4: making a query by said central controller to said window regulating motor regarding the execution status of the window's regulation, and reporting correspondingly by said window regulating motor to said central controller the execution status of said instruction and
Step 4.1: examining by said central controller whether every window concerned has completed its window regulating process: if “Yes”, stopping the window's regulating operation; if “No”, moving to a step (6);

### Step 5: judging whether the time for said window regulating motor to execute said window regulating instruction has gone beyond a limit, if “No”, moving to the step 4; if “Yes”, moving to a step 7 and

### Step 7: actuating by said central controller at least one alarm-unit to send out an alarming signal.

Physically, the automobile window regulating control switch according to an embodiment can include an automobile key, a remote-controlled central locking, a manual window regulator usually attached to the inner side of an automobile door, etc.

According to an embodiment, the alarm can be a conventional sound and/or a light alarm. The alarm also may comprise a wireless communication device for sending a communication request/alarm signal to at least one fixed/mobile communication equipment via a public or specialized wireless communication protocol. When said communication request has been received by a receiving party, it can follow a predetermined procedure to report to the receiving party by way of sound or digital signal which window is or which windows are abnormal and what types of abnormality have occurred.

According to a further embodiment, the above step 4 further comprises Step 4.0: making a query by said central controller to at least one automobile door status sensor regarding an automobile door's shutting status, if “Yes”, moving to the step 4.1; if “No”, moving to the step 7.

According to a further method embodiment, the communication bus between said central controller and window motor is, for example, a LIN bus, and said central controller makes queries periodically to said window regulating motor regarding the execution status of a window regulating instruction.

According to a further embodiment, an apparatus for detecting whether an automobile's window is shut normally, may comprise:
at least one automobile window regulating control switch, connected to a central controller specified below, for issuing regulating requests to said central controller;
a central controller, having communication connection with the above at least one window regulating control switch and having connection with all window controllers by a bus protocol, for receiving from said at least one window regulating control switch the window regulating requests and issuing relevant instructions to a concerned window motor controller (at least one controller); and for issuing query instructions to a concerned window motor controller regarding the window's regulating status, and deciding whether the window concerned should carry on the regulating operation or an alarm should be actuated according to the reply from the window motor controller concerned;
a plurality of window motor controllers, for responding to the window regulating instruction from said central controller and actuating a window motor for a corresponding operation; and for responding to the query instruction regarding window regulating status from said central controller and sending a reply to said central controller;
at least one alarm-unit for responding to an alarm instruction from said central controller to send out an alarming signal.

According to a further embodiment, the apparatus of the present invention may further comprises at least one automobile door status sensor for sensing whether an automobile door has shut and sending said signal to said central controller, and said central controller processes said signal to decide whether to give an alarm.

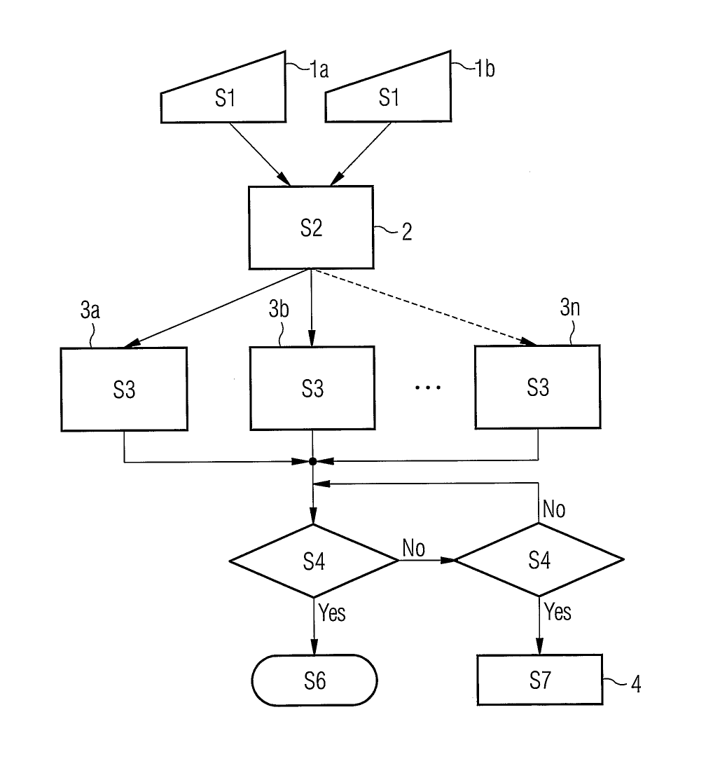

As shown in FIG. 1, a central control lock 1a can be a locking combination for collectively opening or shutting an automobile's doors by inserting an automobile key into a key hole and twisting it; 1b represents a remote control automobile lock. Said central control lock 1a or remote control lock 1b issues a request for shutting the automobile doors to the automobile's central controller 2. After having received said request by the central controller 2, it issues to at least one subsidiary controller 3a, . . . 3n (shown in FIG. 1 as subsidiary controllers based on LIN bus protocol) an instruction to shut the door, and to check continuously the shutting status of the door concerned. When it is confirmed that the door concerned has shut the routine continues to examine by said central controller whether every window concerned has completed its window regulating process as discussed above. Otherwise, the routine continues with the step of actuating one alarm-unit to send out an alarming signal.

It can be seen from the description according to an embodiment, that only the LIN bus is used here as an example for the description of the method and apparatus of the present invention. However, the LIN bus is only one practical embodiment. By using this embodiment, it can effectively solve the technical problem the present invention concerns, and at the same time it can avoid in practical applications the expensive solutions such as using CAN bus.

The number of windows in the present invention is at least one, usually it can be 2, 3, 4, 5 (e.g. 4 windows plus one sunroof) or 6 (e.g. 4 windows at left and right plus one rear window and one sunroof).

There can be a plurality of window regulating control switches 1a;1b, but it is not necessary for them to issue window regulating requests to said central controller 2 at the same time; normal situations would be that one of them needing an operation would send said request to the central controller 2.

In the above embodiment, an automobile's window regulating is used as an example to provide the solution by the present invention. In fact, an automobile's door and window shutting can be done collectively, for example, it can be set that at the time for shutting the automobile's doors, the status of all the automobile's windows is detected and any unshut window would be shut automatically. Therefore, the solution of the present invention covers essentially technical solutions for shutting both automobile's doors and windows at the same time.

What is claimed is:

1. A method for detecting an automobile's window regulating status by using at least one automobile window regulating controller for issuing regulating instructions directly to window equipment, a window central controller, and by using a bus as the protocol for communication between automobile window regulating motors and the central window controller, comprising the steps:
S1) issuing a window regulating request by said at least one window regulating controller to said central controller via said bus;
S2) receiving by said central controller the window regulating request issued by said at least one automobile window regulating controller, and issuing a regulating instruction to a window regulating motor of a respective window;
S3) executing said window regulating instruction by said window regulating motor;
S4) making a query by said central controller to said window regulating motor regarding the execution status of the window's regulation, and reporting accordingly by said window regulating motor to said central controller the execution status of said instruction and
S4.1) examining by said central controller whether every window has completed its window regulating process: if “Yes”, stopping the window's regulating operation in a Step S6; if “No”, moving to a step S5;
S5) judging whether the time for said window regulating motor to execute said window regulating instruction has gone beyond a limit, if “No”, moving to the step S4; if “Yes”, moving to a step S7 and
S7) actuating by said central controller at least one alarm-unit to send out an alarming signal.

2. The method according to claim 1, wherein the step S4 further comprises: S4.0, making a query by said central controller to at least one automobile door status sensor regarding an automobile door's shutting status, if “Yes”, moving to the step S4.1; if “No”, moving to the step S7.

3. The method according to claim 1, wherein said communication bus between said central controller and window regulating motor is a LIN bus, and said central controller makes queries periodically to said window regulating motor regarding the execution status of a window regulating instruction.

4. An apparatus for detecting an automobile's window regulating status, comprising:
at least one automobile window regulating control switch, connected to a central controller, for issuing regulating requests to said central controller, wherein the central controller communication connection with the at least one window regulating control switch and having connection with all window controllers by a bus protocol, for receiving from said at least one window regulating control switch the window regulating requests and issuing relevant instructions to a respective window motor controller; and for issuing query instructions to the respective window motor controller regarding the window's regulating status, and deciding whether the respective window should carry on the regulating operation or an alarm should be actuated according to the reply from the respective window motor controller;
at least one window motor controller, for responding to the window regulating instruction from said central controller and actuating a window motor for a corresponding operation; and for responding to the query instruction regarding window regulating status from said central controller and sending a reply to said central controller and
at least one alarm-unit for responding to an alarm instruction from said central controller to send out an alarming signal.

5. The apparatus according to claim 4, wherein said automobile window regulating control switch is selected form the group consisting of an automobile key, a central control lock and a manual window regulator usually attached to the inner side of an automobile door.

6. The apparatus according to claim 4, wherein said alarming signal is selected from the group consisting of a sound alarm, a light alarm and a sound-light alarm.

7. The apparatus according to claim 4, wherein said alarm-unit comprises a wireless communication device for sending a communication request/alarm signal to at least one fixed/mobile communication equipment; after said communication request has been received by a receiving party, it can follow a predetermined procedure to report to the receiving party by way of sound or digital signal which window is or which windows are abnormal and what types of abnormality have occurred.

8. The apparatus according to claim 4, further comprising at least one automobile door status sensor for sensing whether an automobile door has shut and sending said signal to said central controller, and said central controller processes said signal to decide whether to give an alarming signal.

9. A method for detecting an automobile's window regulating status comprising the steps:
issuing a window regulating request by at least one window regulating controller to a central controller via a bus;
receiving the window regulating request by said central controller, and issuing a regulating instruction to a window regulating motor;
executing said window regulating instruction by said window regulating motor;
making a query by said central controller to said window regulating motor regarding the execution status of the window's regulation, and reporting by said window regulating motor to said central controller the execution status of said instruction;
examining by said central controller whether the window has completed its window regulating process and
if “Yes”, stopping the window's regulating operation;
if “No”, judging whether the time for said window regulating motor to execute said window regulating instruction has gone beyond a limit,
if “No”, repeating said query;
if “Yes”, actuating by said central controller at least one alarm-unit to send out an alarming signal.

10. The method according to claim 9, wherein the query further comprises: making a query by said central controller to at least one automobile door status sensor regarding an automobile door's shutting status.

11. The method according to claim 9, wherein said communication bus between said central controller and window regulating motor is a LIN bus, and said central controller makes queries periodically to said window regulating motor regarding the execution status of a window regulating instruction.
